(19) United States
(12) Patent Application Publication
(10) Pub. No.: US 2023/0342102 A1
(43) Pub. Date: Oct. 26, 2023

(54) UNIVERSAL SCREEN CONTENT CAPTURE

(71) Applicant: Citrix Systems, Inc., Fort Lauderdale, FL (US)

(72) Inventor: Alexandr Smelov, North Lauderdale, FL (US)

(21) Appl. No.: 17/821,514

(22) Filed: Aug. 23, 2022

Related U.S. Application Data
(60) Provisional application No. 63/333,405, filed on Apr. 21, 2022.

(51) Int. Cl. G06F 3/14; H04L 65/403

(52) U.S. Cl. CPC G06F 3/1454; H04L 65/403

(57) ABSTRACT

Methods and systems for selectively capturing screen content are described herein. The projector associated with a plurality of layers may be initiated. The plurality of layers may comprise a surface layer that is a highest layer, a canvas layer that is the lowest layer and backdrop layer that is second lowest layer. Input associated with the positioning of the projector may be received. The portions of content may be determined to be between the surface layer and the backdrop layer and captured.

### CROSS-REFERENCE TO RELATED APPLICATION

This application claims priority to U.S. Provisional Patent Application Ser. No. 63/333,405, filed Apr. 21, 2022 and entitled “SELECTIVE SCREEN CONTENT SHARING.” The prior application is herein incorporated by reference in its entirety for all purposes.

### FIELD

Aspects described herein generally relate to computer networking, remote computer access, virtualization, enterprise mobility management, screen capture, and hardware and software related thereto. More specifically, one or more aspects describe herein provide universal system for capturing screen content.

### BACKGROUND

There are many applications in existence that record computer screen content. Most common categories are online meetings (e.g., MICROSOFT TEAMS, ZOOM, etc.), broadcasting, and video content creation apps. Almost all of them include capabilities to record a whole screen or a single content window, for example a text editor window.

Recording whole screen is oftentimes excessive—it contains too much content, which might be distracting for consumers or is a privacy concern for creator. Additionally recorded screen size could be too big for some consumers who may watch on smaller screens creating usability issues.

Recording a single content window has its own issues. It may show too little content, because there is frequently a need to show multiple windows or sub-windows at the same time. Or just like for the whole screen, it displays too much content. Showing toolbars or menus does not add value to the presentation, it rather distracts. Additionally, switching between windows during recording slows it down or even results in errors of getting correct window to be shown.

### SUMMARY

The following presents a simplified summary of various aspects described herein. This summary is not an extensive overview and is not intended to identify required or critical elements or to delineate the scope of the claims. The following summary merely presents some concepts in a simplified form as an introductory prelude to the more detailed description provided below.

One solution to the problems with recording whole screen or a single window could be adding a capability of recording a portion of screen (sub-screen) that could contain any content, for example several windows at once or portions of windows. Some recording applications already have this capability, but only a few. Adding such capability to all recording apps is possible but prohibitively expensive.

A better approach is to introduce an intermediary between the content and the recording application that can capture arbitrary content. The captured content can be subsequently recorded unobtrusively, and compatibly with any recording application.

A single window could represent a sub-screen because it has a position (position encompasses length, width, and location on the screen), just like a sub-screen would. Moreover, recording applications already have a capability to record a single window. A method is needed to populate such window transparently and unobtrusively with the content that needs to be captured in a way that is compatible with recording application's existing methods of recording windows.

Recording applications typically use one of two methods to record single application window content. In some implementations they could use either method depending on platform capabilities.

The first method is recording a sub-screen that corresponds to the position of the window. This is an older method and has some issues associated with it due to an intrinsic requirement for the window to be on top of all other windows. To ensure only the selected window is captured, recording app may assume the window is unobscured by other windows (not secure) or attempt to force window on top (failure prone) or pause recording until user moves window on top (bad user experience). The advantage of this method is its availability on almost all platforms.

The second, more modern, reliable and performant method, is to record actual window content regardless of window's slot in the visual stack. Even when the window is hidden behind other windows it will be reliably recorded without interruptions. This method, due to its relative newness, is not universally available on all platforms.

As of today, there is about 50/50 split between these methods being used by recording applications. To make an intermediary universally applicable, it is necessary to support both methods in a way that regardless of the method, a desired sub-screen would be accurately recorded.

To overcome limitations in the prior art described above, and to overcome other limitations that will be apparent upon reading and understanding the present specification, aspects described herein are directed towards an intermediary application that enables universal content capture.

In some examples, a computing device may initiate a projector application comprising a plurality of layers including a surface layer, a canvas layer, and a backdrop layer. The surface layer is the highest layer in the plurality of layers that is positioned above the canvas and backdrop layers in the visual stack. The surface layer may be transparent (i.e., visually see-through) and enable user input to be applied to through the surface layer to lower layers (i.e., interactively click-through). The surface layer may be automatically slotted above all layers and portions of content (i.e., content windows) in between the layers in the visual stack. According to some embodiments, when a recording application records the surface layer of the projector application, it uses the surface layer's position as a sub-screen position. The sub-screen may contain any content layers positioned below the surface layer, for example whole multiple windows, portions of window, mix of portions and whole windows, etc. This allows a user to see and interact with content as if the surface layer did not exist satisfying unobtrusiveness requirement.

According to some embodiments, the plurality of layers includes a canvas layer. The canvas layer maybe automatically slotted below all content layers (i.e., content windows) in the visual stack. According to some embodiments, the projector application captures and displays the content above the canvas layer in the visual stack exactly as seen by the user. This approach takes advantage of the ability of recording application's ability to record application windows anywhere in the visual stack. The content displayed on the canvas layer may be communicated to the recording application even if content windows are above the canvas layer in the visual stack, and the canvas layer itself is not visible to the user. It also satisfies the unobtrusiveness requirement because all content is above the canvas layer. The user can see and interact with the layers above the canvas layer without the canvas layer getting in the way. In other words, when recording application records the canvas layer, it effectively records the content layers positioned above the canvas layer, for example whole multiple windows, portions of window, mix of portions and whole windows, etc.

According to some embodiment, the canvas layer displays the content as seen by the user through the surface layer. The canvas layer is, just like the surface, non-interactive for user, but for a different reason—it is hidden below the content instead of being transparent. The canvas and surface layers are slotted on the opposite ends of the visual stack but have same position on the screen to ensure either recording method can be used with same results.

According to some embodiments, to capture content, the canvas layer includes recording and playback components operating in real time with the position of recording corresponding exactly with the position of playback which corresponds to the canvas window itself. Every frame of sub-screen content (i.e., content windows) that is recorded is played back as soon as possible on the canvas to be subsequently consumed by the recording application.

Content rendering, recording and playback are asynchronous at the platform level. The user eventually sees a composition of various windows on the screen, but internally, each of those windows could be rendered at slightly different time. This means there is a slight delay between content that the user sees at a particular moment in time and what the canvas layer displays.

This is not a problem when content fully overlaps the canvas layer or at least the portion of the canvas layer that is not covered by content does not change, because every frame only contains content and will eventually be drawn on the canvas layer. But when a content window moves, for example by user dragging it across the screen thus changing the portion of the canvas layer that is exposed, then asynchrony would create a visual corruption on the canvas layer, because the recording component would record a portion of the canvas itself that was displaying content that is slightly outdated and there is no other content above in visual stack to overwrite the canvas layer. The backdrop layer solves this issue.

According to some embodiments, the backdrop layer may be an opaque window slotted directly above the canvas layer and below all content windows in the visual stack and positioned on screen exactly the same as the canvas and surface layers. In other words, the canvas, surface and backdrop layers may positionally align as shown in FIG. 5. In some examples, the backdrop layer is effectively a content window that is always present and always fully overlaps canvas layer thus eliminating canvas' visual corruption. The backdrop may display a solid color, an image, or any other type of content chosen by the user. Visually, the backdrop layer serves as a background for the sub-screen similar to the desktop wallpaper serving as a background for the screen.

In some embodiments, a computing device may initiate a projector application (i.e., screen content capturing application containing the projector) comprising a plurality of layers. The plurality of layers including a surface layer that is a highest layer, a canvas layer that is a lowest layer, and backdrop layer that is the second lowest. In some embodiments, the surface layer is transparent and enables user input to be applied to through the surface layer to the lower layers.

According to some embodiments, the computing device may receive one or more inputs associated with the positioning of one or more portions of content and/or the positioning of the projector. The computing device may determine that the one or more portions of content are between the surface layer and the backdrop layer, and directly above the canvas layer in the visual stack. The computing device may capture the one or more portions of content between the surface layer and the backdrop layer and directly above the canvas layer, and display the captured content on the canvas layer.

In some embodiments, the computing device may communicate the captured content to one or more recording applications. For example, a user may choose to share the projector application on a meeting application to display for other users. The captured content displayed on the canvas layer is communicated to the meeting application. In some embodiments, the one or more recording applications record the surface layer of the projector application. The surface layer being transparent, the content (and in some cases the backdrop layer) directly under the surface layer would be recorded by the one or more recording applications. This enables the user to share multiple portions of content from different application windows without sharing the user's full screen.

In some embodiments, capturing the one or more portions of content between the surface layer and the backdrop layer includes capturing a portion of the backdrop layer. The captured portion of the backdrop layer may not have the one or more portions of content above it. In some embodiments, displaying includes displaying the captured portion of the backdrop layer on the canvas layer.

In some examples, the one or more inputs may include sub-screen positioning on the screen.

In some examples, the computing device may generate a watermark that is superimposed over the captured content.

Corresponding apparatuses, devices, systems, and computer-readable media (e.g., non-transitory computer-readable media) are also within the scope of the disclosure.

These and additional aspects will be appreciated with the benefit of the disclosures discussed in further detail below.

### BRIEF DESCRIPTION OF THE DRAWINGS

A more complete understanding of aspects described herein, and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an example representation of a plurality of layers including content for capture in accordance with example implementations of the present disclosure.

FIG. 6 depicts a diagram of a screen and content for capture in accordance with one or more aspects of the present disclosure.

FIG. 7 depicts a platform architecture for a content sharing system that may be used in accordance with one or more aspects described herein.

FIG. 8 depicts a flowchart showing an example method for sharing content in accordance with one or more aspects of the present disclosure.

FIG. 9 depicts a schematic representation of data movement for transmission of shared content data.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed to capturing screen content and in particular to selectively controlling the capturing of content from a presenter's computing device. A user may run (i.e., initiate) a projector application (e.g., an instance of a projector) on a computing device (e.g., a user's laptop computing device). The projector application will receive inputs to determine the content of the user's computing device that may be captured. The projector may determine visual content that may be selectively captured based on the input.

In particular, the disclosed technology may determine a topmost surface layer, a bottommost canvas layer and the second from the bottom backdrop layer between which a content (or content windows) layer or multiple layers may be contained. The user may control the content and the way in which the content is presented. The backdrop ensures the canvas has accurate representation of the content above it in the visual stack. Additionally, the backdrop maintains the privacy of a user's desktop by hiding it. In this way, the disclosed technology provides various technical effects and benefits including more effective capturing of screen content, improved protection of privacy, and a reduction in usage of resources due to more selective capturing of screen content.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

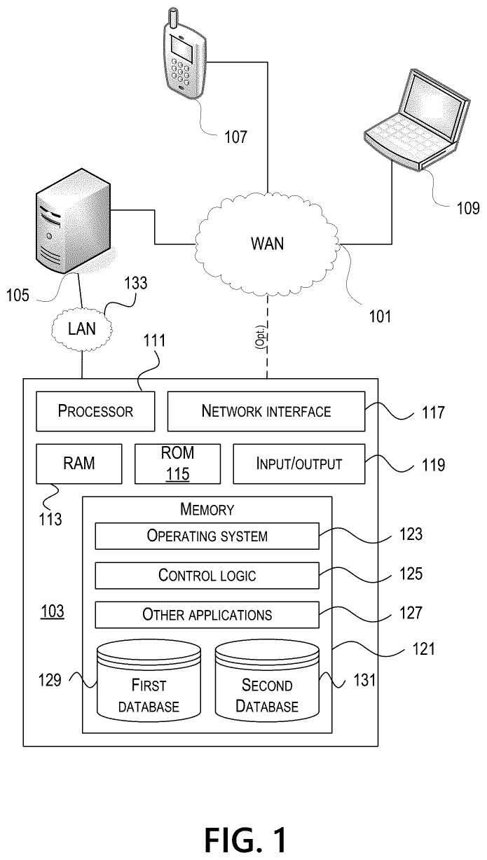

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

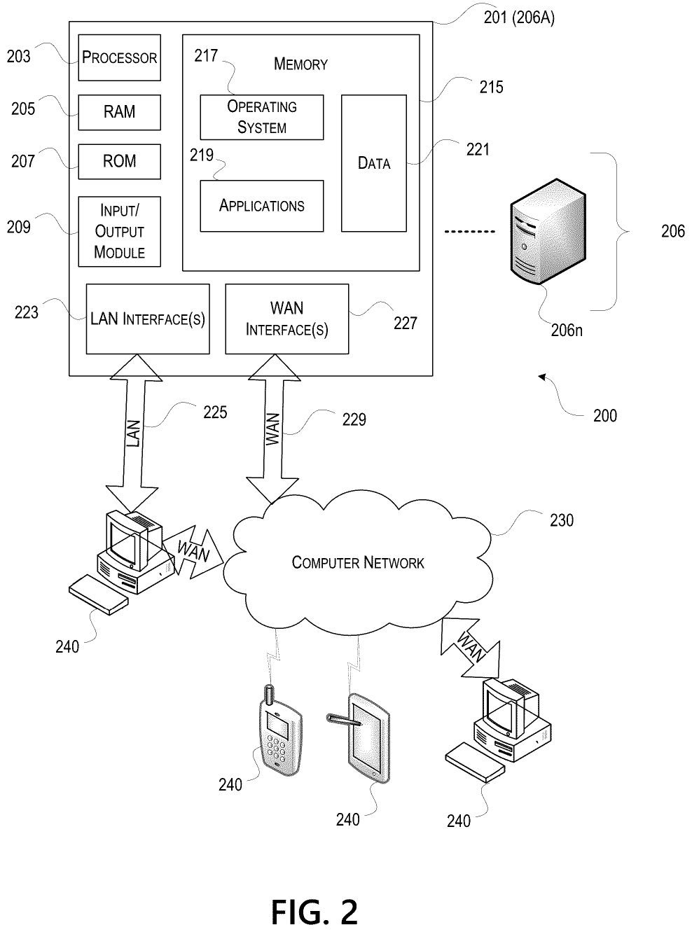

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over the computer network 230, e.g., network 101.

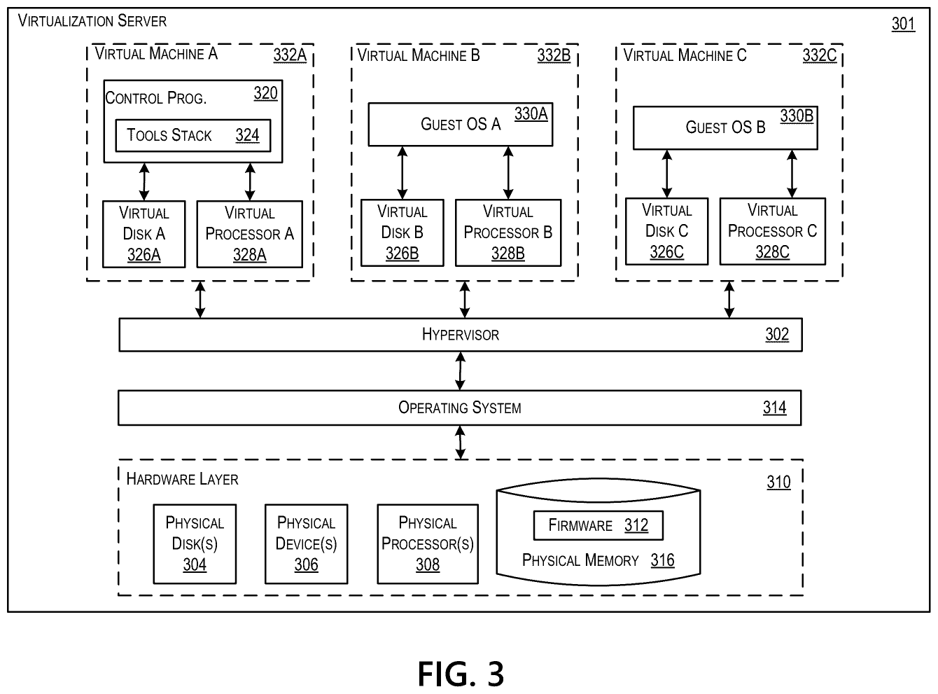

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

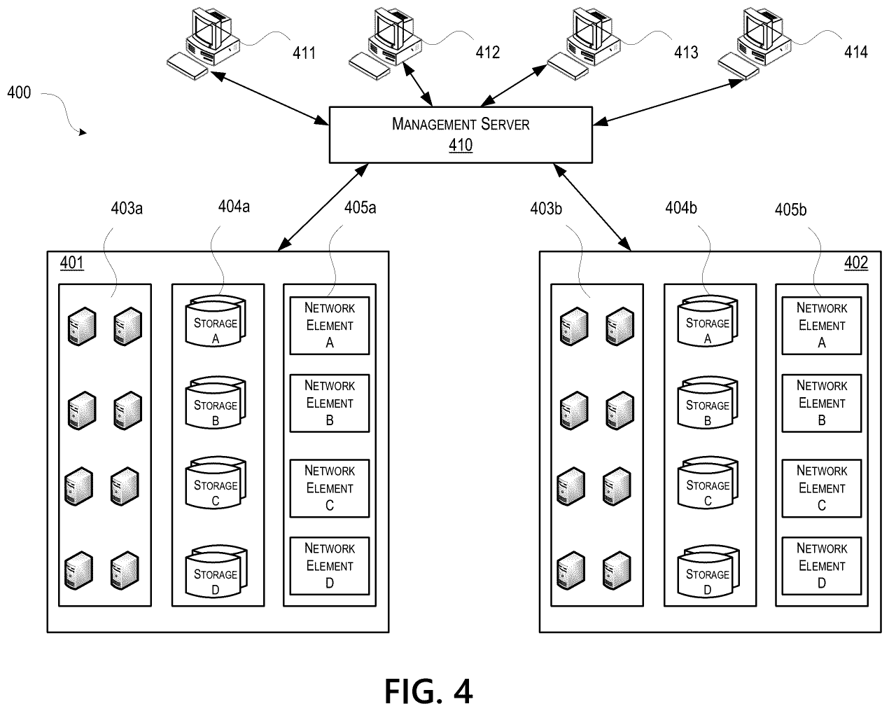

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

### Screen Content Capturing System

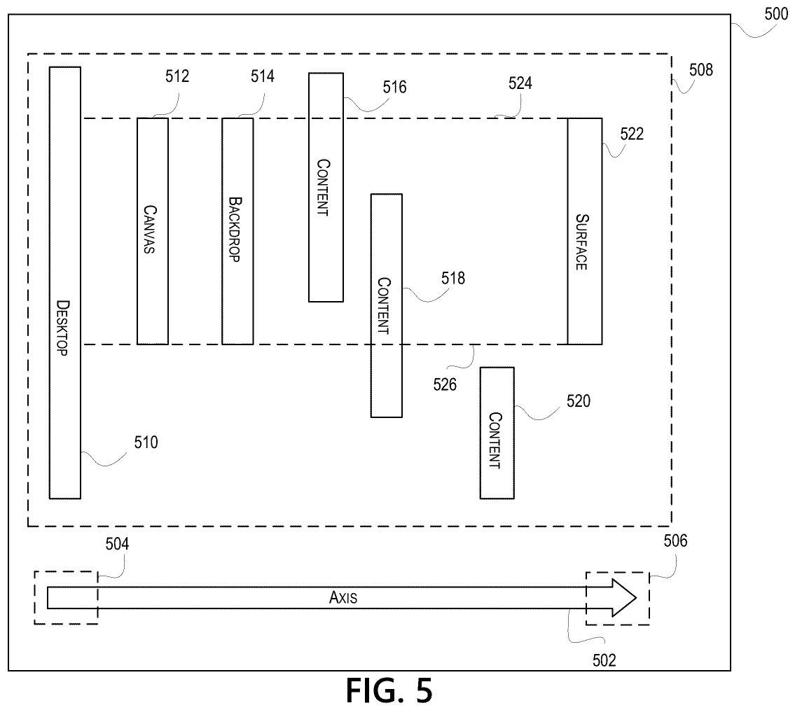

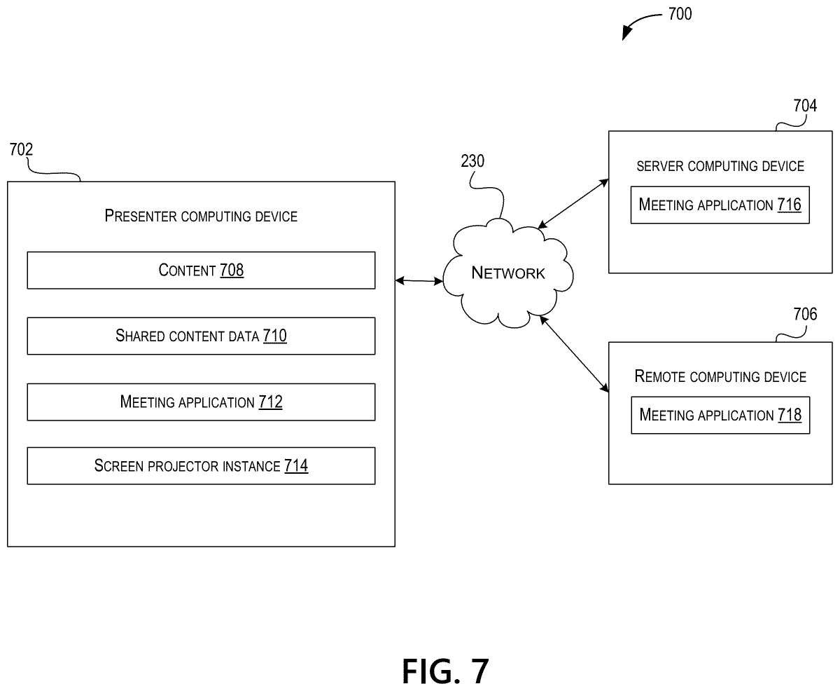

FIG. 5 depicts an example representation of capturing screen content in accordance with example implementations of the present disclosure. The screen 500 may be associated with a display output device that may be used to display content including applications and other visual content. Further, the screen 500 may be generated by a computing device (e.g., the presenter computing device 702 depicted in FIG. 7) that is running a projector application.

The screen 500 may be associated with an axis 502. The axis 502 may be associated with which content has been selected for display/capturing and/or the way in which the content is presented. In particular, the axis 502 may be associated with which content is generated and/or visible on the screen 500, which content is not generated and/or visible on the screen 500, and/or the way in which content is generated with respect to other content (e.g., whether one portion of content overlaps another portion of content). The content elements 508 represent one or more types of content that may be selectively (e.g., based on input) presented, displayed, and/or captured.

In this example, the content (e.g. content windows, or other application windows) is arranged in a plurality of layers ranging from a lowest layer to a highest layer. The content displayed in higher layers (e.g., the content 520) may overlap the content displayed in lower layers (e.g., the content 516). The content may include visual content (e.g., images and/or text) that may be displayed on a screen output device (e.g., a monitor). Further, the content may be captured from other visual content that is generated and/or generated by applications and/or computing devices. For example, the content may include documents (e.g., word processing documents or presentation application documents), web browser content, photographs, and/or any other content that may be displayed using a computing device. The content may include an image comprised of a plurality of points (e.g., pixels) arranged along an x axis and a y axis. The axis 502 (e.g., a z axis that is orthogonal to the x axis and a y axis associated with the content such that each layer of content may be stacked on the axis 502) includes a pole 504 and a pole 506. The pole 504 represents one end of the axis 502 and is associated with the desktop 510. The canvas layer 512 may represent a layer on which all other above layers and content may be displayed, and which has no layers or content beneath it. The pole 506 represents another end of the axis 502 and is associated with the surface layer 522.

The surface layer 522 may represent a layer above which no content may be displayed and below which all other content (and potentially the backdrop layer 514) may be displayed. The surface layer 522 may be transparent such that the layers and content 518,516 below the surface layer 522 may be visible and accessible without the surface layer 522 being visible and accessible. The edge 524 and the edge 526 represent the viewable boundaries of the projector, within which content may be captured and beyond which content is not captured by the projector. In this example, the surface layer 522, the backdrop layer 514 and the canvas layer 512 align exactly on edges 524, 526 of the projector. Further, the size of the surface layer 522 may correspond to the size of the projector. For example, if the projector has dimensions of three thousand (3000) pixels horizontally and two thousand (2000) pixels vertically, the surface layer 522 may have the same dimensions and the canvas layer 512 and backdrop layer 514 may be rendered to the same dimensions.

As shown in FIG. 5, the content 518 overlaps the content 516 which is below the content 518. Further, the portion of the content 518 that is beyond the edge 526 is not captured, the portion of the content 518 and the content 516 that are between the edge 524 and the edge 526 captured, and the portion of the content 516 that is beyond the edge 524 is not captured. Content 520 which is outside of edge 526 is not captured. For example, content that is captured by the projector may be recorded by a meeting application to be presented in a meeting. Likewise, content not captured by the projector is not recorded and presented by a meeting application.

The canvas layer 512 may be a layer that is not visible, and which conforms to the dimensions of the surface layer 522. The backdrop layer 514 may be rendered over the canvas layer 512 and may be visible in the portion of the surface layer 522 that would otherwise display the desktop 510. For example, if there was a horizontal gap between content 518 and content 516, then the portion of the backdrop layer 514 corresponding to the horizontal gap would be visible through the surface layer 522 and displayed on the canvas layer 512. Thus, preventing the canvas layer 512 or the desktop 510 from being captured.

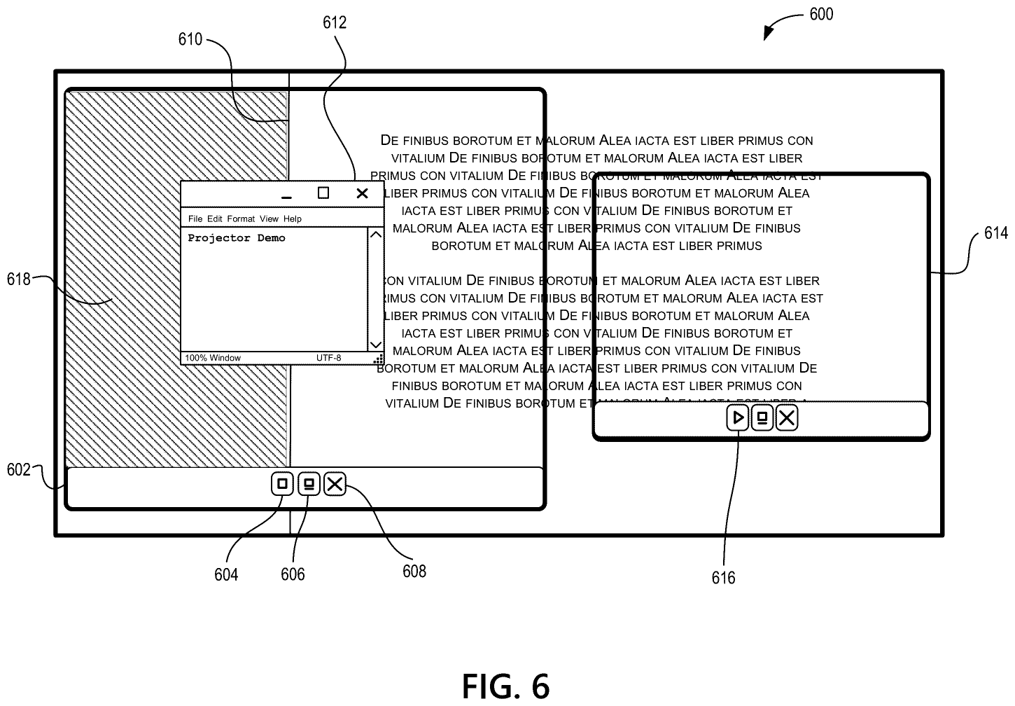

FIG. 6 depicts an example of implementing a projector application on a display device in accordance with the present disclosure. The projector application may include a stage windows to select content for capture. Each stage window represents and encompasses a sub-screen and the projector, comprising surface, canvas and backdrop, would be positioned within one of these sub-screens for content capture. The display 600 includes a stage window 602 and a stage window 614 which encompass different portions of content that is displayed on the display 600. The stage window 602 comprises user interface element 604 which may be used to control whether content associated with the stage window 602 is captured. In this example, the user interface element 604 is in the capturing state and the content associated with the stage window 602 is being captured.

In other embodiments projector application may use configuration files, Application Programming Interfaces (APIs) and other methods to select sub-screens and control capture instead of or in addition to stage windows.

In this example, content 610 (text from a word processing application), content 612 (a notepad application indicating the word “Projector Demo”), and backdrop 618 (a pattern with diagonal stripes) are presented for display within the stage window 602. In this example, the content 612 is prioritized over the content 610 and overlaps the content 610. Furthermore, in this example, a user has selected the content 610 and the content 612 (e.g., by positioning the stage window 602 over the content) for display within the stage window 602. The backdrop 618 may be rendered/displayed where no content was is displayed. The user interface element 606 may be used to generate a new stage window thus creating a new sub-screen. For example, a user interaction with the user interface element 606 may cause the generation of a new stage window. The user interface element 608 may be used to shut down the stage window 602, which may also stop capturing any content that was visible within the stage window 602.

The stage window 614 comprises user interface element 616 which may be used to control whether content within the stage window 614 is captured by the projector. The captured content may be recorded and presented to other computing devices through a recording application (e.g., a meeting application). In this example, the user interface element 604 is in the off state and not in the capture state. As such, content within the stage window 614 visible on the display 600 and is not being captured by the projector.

FIG. 7 depicts a platform architecture for a selective screen content sharing system that may be used in accordance with one or more aspects described herein. As shown in FIG. 7, a presenter computing device 702, server computing device 704, and remote computing device 706 may communicate through computer network 230 (e.g., the computer network 230 that is depicted in FIG. 2). The devices may be implemented or performed, for example, by one or more of the systems discussed with respect to FIGS. 1-4. The devices may operate in a networked environment, for example, transferring data over networks such as the computer network 230 (e.g., the Internet). It will be appreciated that the network connections shown are illustrative and other means of establishing a communications link between the devices may be used.

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

The presenter computing device 702 may be configured to operate/run various applications including meeting applications (e.g., applications for online meetings and collaboration which may include videoconferencing and/or screen sharing capabilities) and projector application which may be used to selectively capture content from the presenter computing device 702 (e.g., documents, images, and/or other content that may be displayed on a display output device associated with the presenter computing device 702. The presenter computing device 702 may be configured to receive one or more user inputs that may be used to select content for sharing with one or more computing devices including the server computing device 704 and the remote computing device 706. The presenter computing device 702 may run a meeting application 712 which may include functionality to share portions of the content 708 which may include visual content that may be displayed on display output devices of the presenter computing device. The presenter computing device 702 may run the projector application 714 which may be an instance of a projector application that is used to capture content displayed by the presenter computing device 702. In some implementations, the meeting application 712 may share the content 708 that is captured by the projector application 714.

The server computing device 704 may be configured to receive and/or send shared content data including the shared content data 710 from the presenter computing device 702. Further, the server computing device 704 may be configured to run the meeting application 716 which may be used to manage communication between the meeting application 712 that runs on the presenter computing device 702 and meeting application 718 that runs on the remote computing device 706. In some implementations, the remote computing device 706 may run an instance of the meeting application 716 that is accessible via a web browser. The presenter computing device 702 and the remote computing device 706 may then access the instance of the meeting application 716 via their respective web browsers.

Remote computing device 706 may comprise a meeting application 718 (e.g., a remote meeting or other collaboration application) that may receive the shared content data 710 and/or data communicated by the meeting application 712. Further, the remote computing device 706 may communicate with the server computing device 704 and receive shared content data that is based on the shared content data 710. For example, the server computing device 704 may communicate the shared content data 710 to other computing devices in addition to the remote computing device 706.

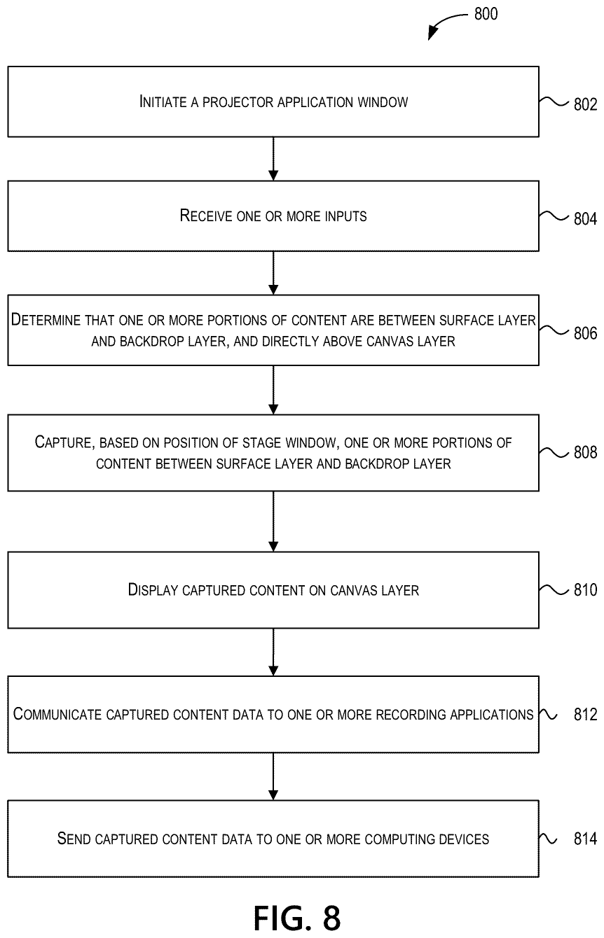

FIG. 8 depicts a flowchart showing an example method for sharing screen content in some implementations. The method may be implemented or performed, for example, by one or more of the systems as discussed with respect to FIGS. 1-7. The method may be implemented or performed, for example, by one or more computing devices and/or computing systems. For example, the method may be implemented by the presenter computing device 702 and/or the server computing device 704 which are depicted in FIG. 5. The steps of the method may be described as being performed by particular components and/or computing devices for the sake of simplicity, but the steps may be performed by any component and/or computing device, or by any combination of one or more components and/or one or more computing devices. Further, the steps of the method may correspond to a set of instructions of an algorithm. By way of example, the algorithm implemented by the method may be used to perform operations including processing data, performing calculations, and/or determining solutions to computational problems. The steps of the method may be performed by a single computing device or by multiple computing devices. One or more steps of the method may be omitted, added, rearranged, and/or otherwise modified.

At step 802, a computing device may initiate a projector application window (e.g., a stage window of the projector application). The projector application may comprise a plurality of layers. Further, the plurality of layers may be visible within the projector application. By way of example, a stage window of the projector application may comprise and/or be associated with a viewport that establishes the dimensions within which the one or more portions of content associated with the plurality of layers are generated and/or displayed.

The plurality of layers may be associated with and/or comprise a surface layer, a canvas layer, and a backdrop layer of the projector. The surface layer may be the highest layer and/or the canvas layer may be the lowest layer and the backdrop is second lowest layer. The plurality of layers above the backdrop layer may overlap the backdrop layer thus overlapping canvas layer. Further, the surface layer may comprise a layer that displays any content that is in the layers below the surface. Further, when content is displayed, the one or more content layers may be visible and may overlap the backdrop layer.

In some embodiments, the stage window of the projector application may include a user interface. One or more portions of content may include one or more images and/or one or more portions of text. For example, the content may include image content of computing applications (e.g., meeting applications, word processors, document viewers, spreadsheet applications, and/or web browsers) that are displayed via a screen output device (e.g., an LCD monitor). Further, the one or more portions of content may include content that is generated on different screen devices. The size and/or shape of the stage window may be adjusted and the stage window may be configured to encompass content including content that is encompassed by one or more other stage windows. In some embodiments, the content (e.g., visual content) may be displayed within dimensions established for one or more viewports of one or more screen devices of the computing device. For example, a user may present content from one or more screen output devices of the computing device.

In some embodiments, the computing device may generate a projector application. The projector application may include the stage window. In some embodiments, the projector application may include a plurality of stage windows. For example, the projector application may be an instance of an application (e.g., a computing application) that is executed, runs, and/or performs operations on the computing device.

The stage windows may comprise a user interface that is configured to receive one or more user inputs via one or more interface elements. For example, stage windows may comprise a graphical user interface that includes one or more user interface elements (e.g., the user interface elements 604-608 that are depicted in FIG. 6). Further, the one or more interface elements may be configured to receive a user input (e.g., a tactile input to a display device with touch sensing capabilities and/or a user input via an input device which may include a mouse or stylus) indicating which of the one or more portions of content to capture and include in the shared content data.

At step 804, a computing device may receive one or more inputs associated with the positioning of one or more portions of content or positioning of the projector. The one or more user inputs may be associated with selection of one or more portions of content for display. For example, the one or more portions of content may overlap the backdrop layer and may be visible through the surface layer. For example, a user input may be received via a graphical user interface that is implemented on the presenter computing device 702. Further, the one or more user inputs may include selection of one or more portions of content for display by clicking on an application that is displayed, moving a stage window (e.g., a stage window that encompasses content in the portion of the display occupied by the stage window) over a portion of content, or creating a boundary (e.g., a rectangular boundary) within which the one or more portions of content are determined to be selected.

At step 806, the computing device may determine that the one or more portions of content are between the surface layer and the backdrop layer, and directly above the canvas layer. Further, the one or more content layers may be between the surface layer and the backdrop layer. The one or more content layers may be based in part on the one or more portions of content that have been selected for display. For example, the presenter computing device 702 may determine the one or more portions of the display that are associated with selection of the one or more portions of content (e.g., any portion of the screen that was selected by the user for display within the stage window). Further, the presenter computing device 702 may determine the position and/or visibility of the one or more intermediate layers with respect to the projector. For example, the presenter computing device 702 may generate the one or more intermediate layers so that the one or more portions of content of the one or more intermediate layers overlap the backdrop layer that occupies the same stage window.

In some embodiments, the one or more content layers may be associated with one or more portions of the content. For example, the one or more user inputs may include selection of two (2) portions of content including a document and a photograph. The two (2) portions of content may be associated with two content layers comprising an content layer for the content associated with the document and another content layer for the content associated with the photograph. The one or more user inputs may be used to determine the visibility and/or position of the two content layers associated with the stage window.

At step 808, the computing device may capture, based on position of the stage window, the one or more portions of content between the surface layer and the backdrop layer. In some embodiments, capturing the one or more portions of content may comprise determining a visibility priority for the one or more portions of content. The visibility priority for the one or more portions of content may be based in part on an order in which the one or more portions of content were selected by the user. For example, if two (2) portions of content comprising a first portion that was selected before a second portion associated with a second portion, the first portion would have a higher visibility priority with respect to the second portion. In some embodiments, certain content may be associated with a default visibility priority in which certain content (e.g., applications and/or documents) have a higher visibility priority compared to other content. For example, a default visibility priority may give document viewing applications higher visibility priority over web browsers and give web browsers higher visibility priority over e-mail applications.

In some embodiments, more recently selected content may have higher visibility priority over less recently selected content. For example, if a user selects a presentation document after selecting a photograph, the presentation document would have a higher visibility priority than the photograph. In some embodiments, more recently selected content may have lower visibility priority with respect to less recently selected content. For example, if a user selects a video before selecting a word processing document, the video would have a higher visibility priority than the word processing document.

In some embodiments, determining a visibility priority for the one or more portions of content is based on the order of the portions of content in the visual stack. For example, portions of content that are higher in the visual stack (i.e., closer to the surface layer) are prioritized over the portions of content lower in the visual stack (i.e., closer to the backdrop layer).

At step 810, the computing device may display, the captured content on the canvas layer. The computing device may display the one or more portions of content based in part on the visibility priority. For example, if a user selected a document after selecting a web browser, the document which was the more recently selected application may overlap the web browser.

At step 812, the computing device may communicate the captured content to one or more recording applications. The captured content may be based in part on the selection of the stage window. For example, when one (1) stage window has been initiated the computing device may communicate captured content data that is based on the one or more portions of content that are associated with the stage window. In some embodiments, the captured content that is displayed on the canvas layer is communicated (i.e., sent) to one or more recording applications. In some embodiments, the one or more recording applications may record the surface layer of the stage window. The portions of content visible through the surface layer are recorded by the one or more recording applications.

In some embodiments, the projector application may comprise a plurality of stage windows and one stage window of the one or more stage windows may be active at a time. For example, when one stage window is being projected the computing device may pause or stop projecting of any other stage window. In some embodiments, the shared content data may be based in part on the one or more portions of content that are associated with the one stage window that is active.

In some embodiments, the user input may indicate adjustment of a size of the one or more portions of content that have been selected for display. For example, the user input may control a user interface element that increases (magnifies) or decreases (shrinks) the size of the one or more portions of content that have been selected for display.

In response to receiving the user input indicating adjustment of a size of the one or more portions of content that have been selected for display, the computing device may adjust the size of the one or more portions of content that have been selected for display. For example, content including text in a small font may be adjusted so that the text is displayed in a larger size that is easier to read. By way of further example, content including a large diagram and accompanying notes may be reduced in size so that the diagram and notes are side by side within the same Stage window.

The user input indicating selection of one or more portions of content for display may comprise selection of one or more portions of content that may be included in the shared content data and the one or more portions of content that may not be included in the shared content data. For example, the user input may be based on an input device (e.g., a stylus or mouse) that is used to create one or more boundary lines (e.g., a box) that encloses the one or more portions of content that may be included in the shared content data.

In some embodiments, the shared content data may comprise a video stream of the one or more portions of content that are associated with the stage window. The shared content data may be stored and sent to the one or more remote computing devices later. In some embodiments, the shared content data may be provided to one or more remote computing devices on a real-time or near real-time basis.

At step 814, the computing device may send the captured content to one or more computing devices which may include one or more remote computing devices and/or one or more local computing devices. For example, the computing device may send data including the captured content to one or more remote computing devices via a communications network (e.g., the network 101). The one or more remote computing device may then use the captured content to display (on one or more display output devices) the one or more portions of content that are associated with the stage window.

In some embodiments, the computing device may send the captured content data to one or more applications that the computing device is executing. For example, the computing device may be executing one or more online meeting or collaboration applications. The computing device may send the captured content data from one application that is being executed on the computing device to a different application that is being executed on the computing device. In some embodiments, the computing device may generate a watermark that is superimposed over the one or more portions of content that have been selected for display. For example, a user may select a watermark (e.g., a company logo, a presenter name, and/or a meeting identifier) that is displayed.

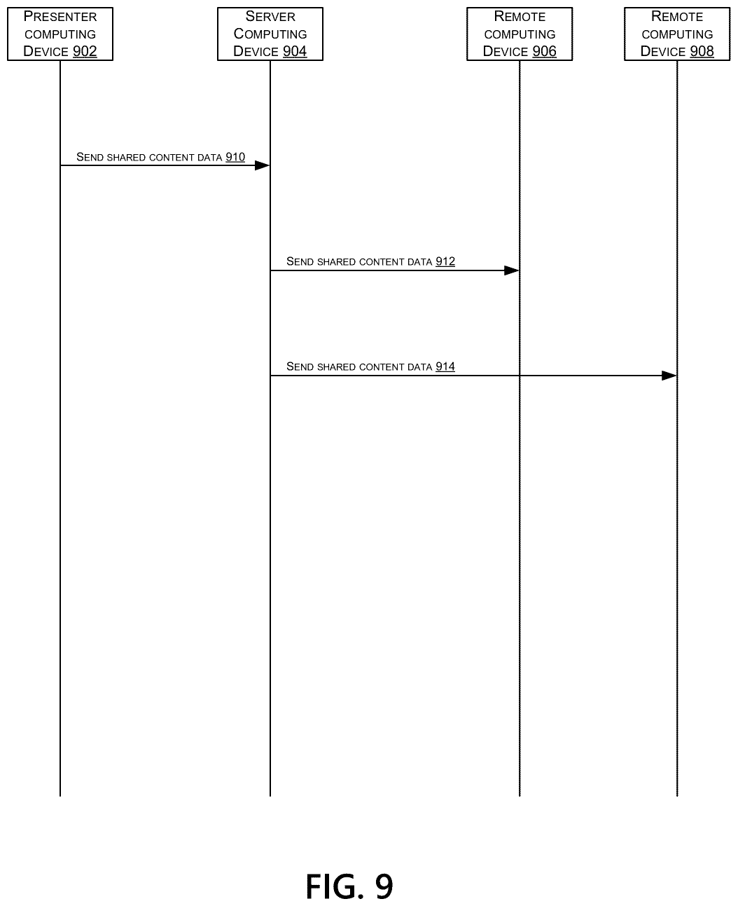

FIG. 9 depicts a schematic representation of transmitting shared content data (e.g., content captured by a projector application) between devices. The transmission of shared content data is shown between the presenter computing device 902 (e.g., a computing device including any of the capabilities and/or features of the presenter computing device 702), the server computing device 904 (e.g., a computing device including any of the capabilities and/or features of the server computing device 704), a remote computing device 906 (e.g., a computing device including any of the capabilities and/or features of the remote computing device 706), and a remote computing device 908. The operations to transmit shared content data may be performed by one or more computing devices. Further, one or more steps and/or one or more operations may be omitted, added, rearranged, and/or otherwise modified.

At step 910, the presenter computing device 902 may send shared content data to the server computing device 904. In some embodiments, the shared content data may be sent as part of a meeting (e.g., an online meeting) that uses a meeting application to share one or more images, video streams, and/or audio that are provided on the presenter computing device 902 with one or more other computing devices including the server computing device 904, the remote computing device 906, and/or the remote computing device 908. For example, the shared content data may include images (e.g., still images and/or a video stream) of contents that are displayed based on a stage window of a projector application that runs on the presenter computing device 902. A user presenting content from the presenter computing device 902 may select one or more portions of content to share with the remote computing device 906 and the remote computing device 908. In this example, the shared content data is sent to the server computing device 904. In some embodiments, the presenter computing device 902 may send one or more portions or versions of the shared content data to the remote computing device 906 and/or the remote computing device 908.

At step 912, the server computing device 904 may receive the shared content data that is sent at the step 910 from the presenter computing device 902. In this example, the server computing device 904 may, after receiving the shared content data from the presenter computing device, generate shared content data which is sent to the remote computing device 906 and which is based on the shared content data sent from the presenter computing device 902.

Further, at step 914 the server computing device 904 may generate shared content data which is sent to the remote computing device 908 and based on the shared content data sent to the server computing device 904 at step 910.

The following paragraphs (M1) through (M8) describe examples of methods that may be implemented in accordance with the present disclosure.

(M1) A method comprising initiating, by a computing device, a projector comprising a plurality of layers, the plurality of layers including a surface layer that is a highest layer, a canvas layer that is a lowest layer and a backdrop layer that is a second lowest layer, wherein the surface layer is transparent and enables user input to be applied through the surface layer; receiving, by the computing device, one or more inputs associated with positioning of one or more portions of content or positioning of the projector; determining, by the computing device, that the one or more portions of content are between the surface layer and the backdrop layer, and directly above the canvas layer; capturing, by the computing device, the one or more portions of content between the surface layer and the backdrop layer; and displaying, by the computing device, captured content on the canvas layer, wherein the captured content comprises the one or more portions of content between the surface layer and the backdrop layer.

(M2) A method may be performed as described in paragraph (M1) wherein the surface layer has dimensions that are equal to dimensions of the canvas and the backdrop layers.

(M3) A method may be performed as described in any of paragraphs (M1) through (M2) further including communicating, by the computing device, the captured content to one or more recording applications.

(M4) A method may be performed as described in any of paragraphs (M1) through (M3) wherein capturing includes capturing a portion of the backdrop layer.

(M5) A method may be performed as described in any of paragraphs (M1) through (M4) wherein displaying includes displaying the captured portion of the backdrop layer on the canvas layer.

(M6) A method may be performed as described in any of paragraphs (M1) through (M5) wherein the one or more inputs may include sub-screen positioning on the screen.

(M7) A method may be performed as described in any of paragraphs (M1) through (M6) further including generating a watermark that is superimposed over the captured content.

(M8) A method may be performed as described in any of paragraphs (M1) through (M7) wherein communicating the captured content to one or more recording applications includes recording, the one or more recording applications, the displayed captured content on the canvas layer.

The following paragraphs (A1) through (A8) describe examples of apparatuses or devices that may be implemented in accordance with the present disclosure.

A computing device comprising: one or more processors; and memory storing instructions that, when executed by the one or more processors, cause the computing device to: initiate a projector comprising a plurality of layers, the plurality of layers including a surface layer that is a highest layer, a canvas layer that is a lowest layer and a backdrop layer that is a second lowest layer, wherein the surface layer is transparent and enables user input to be applied through the surface layer; receive one or more inputs associated with positioning of one or more portions of content or positioning of the projector; determine that that the one or more portions of content are between the surface layer and the backdrop layer, and directly above the canvas layer; capture the one or more portions of content between the surface layer and the backdrop layer; and display captured content on the canvas layer, wherein the captured content comprises the one or more portions of content between the surface layer and the backdrop layer.

(A2) A computing device as described in (A1) wherein the surface layer has dimensions that are equal to dimensions of the canvas and the backdrop layers.

(A3) A computing device as described in any of paragraphs (A1) through (A2) wherein the instructions that, when executed by the one or more processors, further cause the computing device to communicate the captured content to one or more recording applications.

(A4) A computing device as described in any of paragraphs (A1) through (A3) wherein capturing includes capturing a portion of the backdrop layer.

(A5) A computing device as described in any of paragraphs (A1) through (A4) wherein displaying includes displaying the captured portion of the backdrop layer on the canvas layer.

(A6) A computing device as described in any of paragraphs (A1) through (A5) wherein the one or more inputs may include sub-screen positioning on the screen.

(A7) A computing device as described in any of paragraphs (A1) through (A6) wherein communicating the captured content to one or more recording applications includes recording, by the one or more recording applications, the displayed captured content on the canvas layer.

(A8) A computing device as described in any of paragraphs (A1) through (A7) wherein the instructions that, when executed by the one or more processors, further cause the computing device to generate a watermark that is superimposed over the captured content.

The following paragraphs (CRM1) through (CRM4) describe examples of computer-readable media that may be implemented in accordance with the present disclosure.

(CRM1) One or more non-transitory computer-readable media storing instructions that, when executed, cause a computing device to: initiate a projector comprising a plurality of layers, the plurality of layers including a surface layer that is a highest layer, a canvas layer that is a lowest layer and a backdrop layer that is a second lowest layer, wherein the surface layer is transparent and enables user input to be applied through the surface layer; receive one or more inputs associated with positioning of one or more portions of content or positioning of the projector; determine that that the one or more portions of content are between the surface layer and the backdrop layer, and directly above the canvas layer; capture the one or more portions of content between the surface layer and the backdrop layer; and display captured content on the canvas layer, wherein the captured content comprises the one or more portions of content between the surface layer and the backdrop layer.

(CRM2) One or more non-transitory computer-readable media as described in paragraph (CRM1), wherein the surface layer has dimensions that are equal to dimensions of the canvas and the backdrop layers.

(CRM3) One or more non-transitory computer-readable media as described in any of paragraphs (CRM1) through (CRM2), further storing instructions that, when executed, cause a computing device to communicate the captured content to one or more recording applications.

(CRM4) One or more non-transitory computer-readable media as described in any of paragraphs (CRM1) through (CRM3), wherein the capturing includes capturing a portion of the backdrop layer.

Although the subject matter has been described in language specific to structural features and/or methodological acts, it is to be understood that the subject matter defined in the appended claims is not necessarily limited to the specific features or acts described above.

Rather, the specific features and acts described above are described as example implementations of the following claims.

What is claimed is:

1. A method comprising:
initiating, by a computing device, a projector comprising a plurality of layers, the plurality of layers including a surface layer that is a highest layer, a canvas layer that is a lowest layer and a backdrop layer that is a second lowest layer, wherein the surface layer is transparent and enables user input to be applied through the surface layer;
receiving, by the computing device, one or more inputs associated with positioning of one or more portions of content or positioning of the projector;
determining, by the computing device, that the one or more portions of content are between the surface layer and the backdrop layer, and directly above the canvas layer;
capturing, by the computing device, the one or more portions of content between the surface layer and the backdrop layer; and
displaying, by the computing device, captured content on the canvas layer, wherein the captured content comprises the one or more portions of content between the surface layer and the backdrop layer.

2. The method of claim 1, wherein the surface layer has dimensions that are equal to dimensions of the canvas and the backdrop layers.

3. The method of claim 1, further including communicating, by the computing device, the captured content to one or more recording applications.

4. The method of claim 1, wherein capturing includes capturing a portion of the backdrop layer.

5. The method of claim 4, wherein displaying includes displaying the captured portion of the backdrop layer on the canvas layer.

6. The method of claim 1, wherein the one or more inputs may include sub-screen positioning on the screen.

7. The method of claim 1, further including generating a watermark that is superimposed over the captured content.

8. The method of claim 3, wherein communicating the captured content to one or more recording applications includes recording, the one or more recording applications, the displayed captured content on the canvas layer.

9. A computing device comprising:
one or more processors; and
memory storing instructions that, when executed by the one or more processors, cause the computing device to:
initiate a projector comprising a plurality of layers, the plurality of layers including a surface layer that is a highest layer, a canvas layer that is a lowest layer and a backdrop layer that is a second lowest layer, wherein the surface layer is transparent and enables user input to be applied through the surface layer;
receive one or more inputs associated with positioning of one or more portions of content or positioning of the projector;
determine that that the one or more portions of content are between the surface layer and the backdrop layer, and directly above the canvas layer;
capture the one or more portions of content between the surface layer and the backdrop layer; and
display captured content on the canvas layer, wherein the captured content comprises the one or more portions of content between the surface layer and the backdrop layer.

10. The computing device of claim 9, wherein the surface layer has dimensions that are equal to dimensions of the canvas and the backdrop layers.

11. The computing device of claim 9, wherein the instructions that, when executed by the one or more processors, further cause the computing device to communicate the captured content to one or more recording applications.

12. The computing device of claim 9, wherein capturing includes capturing a portion of the backdrop layer.

13. The computing device of claim 12, wherein displaying includes displaying the captured portion of the backdrop layer on the canvas layer.

14. The computing device of claim 9, wherein the one or more inputs may include sub-screen positioning on the screen.

15. The computing device of claim 11, wherein communicating the captured content to one or more recording applications includes recording, by the one or more recording applications, the displayed captured content on the canvas layer.

16. The computing device of claim 9, wherein the instructions that, when executed by the one or more processors, further cause the computing device to generate a watermark that is superimposed over the captured content.

17. One or more non-transitory computer-readable media storing instructions that, when executed, cause a computing device to:
initiate a projector comprising a plurality of layers, the plurality of layers including a surface layer that is a highest layer, a canvas layer that is a lowest layer and a backdrop layer that is a second lowest layer, wherein the surface layer is transparent and enables user input to be applied through the surface layer;
receive one or more inputs associated with positioning of one or more portions of content or positioning of the projector;
determine that that the one or more portions of content are between the surface layer and the backdrop layer, and directly above the canvas layer;
capture the one or more portions of content between the surface layer and the backdrop layer; and
display captured content on the canvas layer, wherein the captured content comprises the one or more portions of content between the surface layer and the backdrop layer.

18. The one or more non-transitory computer-readable media of claim 17, wherein the surface layer has dimensions that are equal to dimensions of the canvas and the backdrop layers.

19. The one or more non-transitory computer-readable media of claim 17, further storing instructions that, when executed, cause a computing device to communicate the captured content to one or more recording applications.

20. The one or more non-transitory computer-readable media of claim 17, wherein the capturing includes capturing a portion of the backdrop layer.
